(19) United States
(12) Patent Application Publication
(10) Pub. No.: US 2003/0208914 A1
(43) Pub. Date: Nov. 13, 2003

(54) Extendable handle shaver

(76) Inventors: Ronald William Ehrlich, Palatine, IL (US); Karen Ann Wolak, Hoffman Estates, IL (US)

Correspondence Address: Karen A. Wolak, 4607 Burnham Dr., Hoffman Estates, IL, 60195, US

(21) Appl. No.: 10/142,180

(22) Filed: May 9, 2002

(51) Int. Cl. B26B 21/40

(52) U.S. Cl. 30/526; 30/537

(57) ABSTRACT

The shaving device includes an extendable handle via a connecting rod with an angular bend whereby the handle may be extended by a connecting rod which fits inside said handle to desired variable length to adjust to different body sizes, such as approximately 12 to 18 inches and the angular bend may also be variable to adjust to different body sizes, such as approximately 30-45 degrees. The characteristic of the shaving device allows shaving hard to reach areas, such as the back. The shaving device may further comprise a disposable shaving blade attachment and switch mechanism for a detachable blade. If desired, the shaving device may further also comprise a detachable shaving cream applicator.

### BACKGROUND OF THE INVENTION

1. Field of the Invention

The present invention relates to shaving devices for hard to reach body areas and methods of using such shaving devices.

2. Description of the Related Arts

Although shaving devices on the marketplace are commonly used to shave various parts of the body, these shaving devices are typically designed for easy to reach areas of the body, existing shavers are not designed for hard to reach areas of the body, particularly the back. For example, existing shavers may be of insufficient length or flat and therefore do not align with the contour of the body. Consequently, the existing shavers cannot shave the back and other hard to reach body areas because the handle does not extend to the back or does not curve to the body contour.

Therefore, a need still exits for a shaving device with a handle of sufficient length that reaches difficult to reach areas and is able to align with body contours instead of laying flat.

### SUMMARY OF THE INVENTION

The purpose and advantages of the present invention will be set forth in and apparent from the description that follows, as well as will be learned by practice of the invention. Additional advantages of the invention will be realized and attained by the devices and methods particularly pointed out in the written description and claims hereof, as well as from the appended drawings.

To achieve these and other advantages, as embodied and broadly described, the invention includes a shaving device with an extendable handle and an angular bend whereby the handle may be extended by a connecting rod which fits inside said handle to a desired variable length, such as approximately 12 to 18 inches, to adjust to different body sizes and the angular bend may also be varied, such as approximately 30-45 degrees, to adjust to different body sizes. The characteristic of the shaving device allows shaving hard to reach areas, such as the back. The shaving device may further comprise a disposable shaving blade attachment and switch mechanism for a detachable blade. If desired, the shaving device may further also comprise a detachable shaving cream applicator.

It is to be understood that both the foregoing general description and the following detailed description are exemplary and are intended to provide further explanation of the invention claimed.

The accompanying drawing, which is incorporated in and constitutes part of this specification, is included to illustrate and provide a further understanding of the invention. Together with the description, the drawing serves to explain the principles of the invention.

### BRIEF DESCRIPTION OF THE DRAWINGS

FIG. 1 is a schematic representation of the extendable handle shaver in accordance with the invention.

### DETAILED DESCRIPTION OF THE PREFERRED EMBODIMENT

References will now be made in detail to the present preferred embodiments of the invention, an example of which is illustrated in the accompanying drawing. The method and corresponding steps of the invention will be described in conjunction with the detailed description of the system.

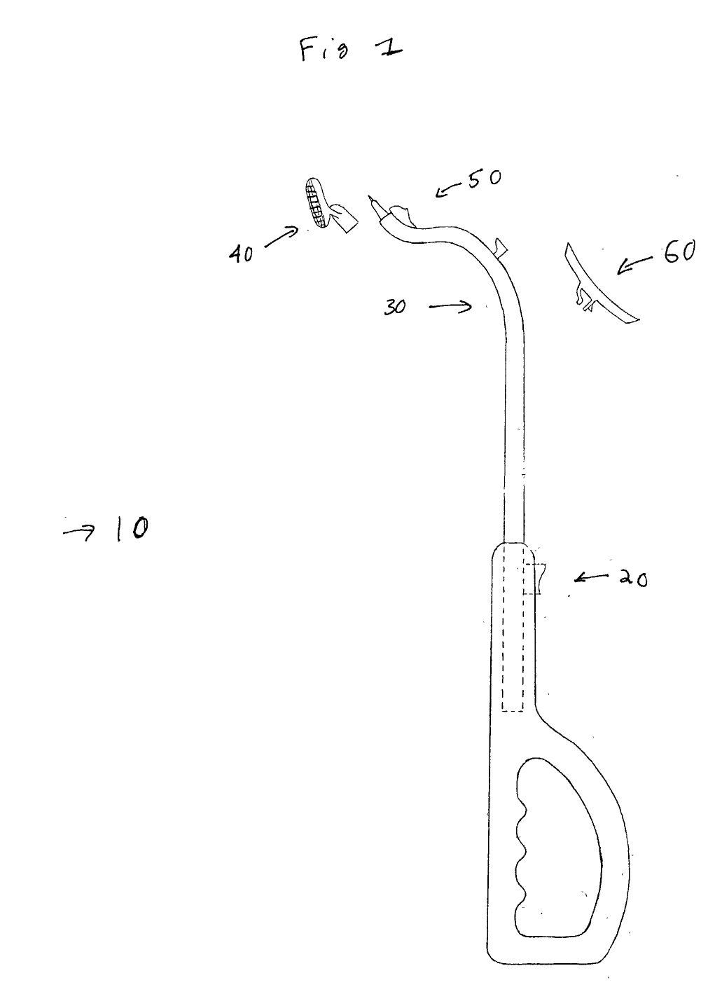

The devices and methods presented herein may be used to shave hard to reach body areas. The present invention is particularly suited for shaving the back. For purposes of explanation and illustration, and not limitation, an exemplary embodiment of the shaving device in accordance with the invention is shown in FIG. 1.

As shown in FIG. 1, the shaving device, 10, comprises of an extendable handle via a connecting rod, 20, with an angular bend, 30. The handle, 20, may be extended to a desired variable length to adjust to different body sizes, such as, for purposes of illustration and explanation and not limitation, approximately 12 to 18 inches. The handle is extendable by a connecting rod that fits inside said handle. The angular bend, 30, may also be variable to adjust to different body sizes, such as, for purposes of illustration and explanation and not limitation, 30-45 degrees.

The shaving device may further comprise a disposable shaving blade attachment, 40, and switch mechanism, 50, for a detachable blade. If desired, the shaving device may further also comprise a detachable shaving cream applicator, 60.

The disclosed shaving device is for purposes of explanation and illustration, not limitation. The disclosed shaving device is suitable with various blade types and may be used to shave various body parts, including but not limited to the back. Furthermore, the shaving device of the invention may also be an electric shaver.

The invention also includes methods of using the disclosed invention of a shaving device with a curved elongated handle. The method comprises of adjusting the handle to a desired length as determined by various body types and shaving the desired body part with the shaving device. The handle may be adjusted to various lengths, such as, for purposes of explanation and illustration and not limitation, approximately 12-18 inches. The curve of the elongated handle, for purposes of explanation and illustration and not limitation, may be approximately 30-45 degrees. Optionally, the method of using the shaving handle may further comprise of applying a shaving cream with a detachable shaving cream applicator. The method may comprise of shaving various body parts such as, for purposes of explanation and illustration and not limitation, the back. Furthermore, the shaving device may be an electric shaver if desired.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

I claim:

1. A shaving device for shaving hard to reach body areas comprising:
a curved elongated handle.

2. The shaving device of claim 1 wherein the hard to reach area is the back.

3. The shaving device of claim 1 wherein said curve of said elongated handle is approximately 30-45 degrees.

4. The shaving device of claim 1 wherein the length of the said handle extendable to by approximately 12-18 inches.

5. The shaving device of claim 1 wherein said handle is extendable by a connecting rod that fits inside said handle.

6. The shaving device of 1 claim further comprising a detachable shaving cream applicator.

7. A method of using a shaving device with a curved elongated handle comprising:
adjusting said handle to desired length; and
shaving desired body part with said shaving device.

8. The method of claim 7 wherein the said hard to reach is the back.

9. The method of claim 7 wherein said curve of elongated handle is approximately 30-45 degrees.

10. The method of claim 7 wherein the length of the said handle is approximately 12-18 inches

11. The method of claim 7 further comprising of applying a shaving cream with a detachable shaving cream application
